(19) United States
(12) Patent Application Publication
(10) Pub. No.: US 2020/0111131 A1
(43) Pub. Date: Apr. 9, 2020

(54) METHOD OF PROVIDING NEEDS-BASED ADVERTISING

(71) Applicants: David Crismon, Herriman, UT (US); Monte Johnson, Springville, UT (US)

(72) Inventors: David Crismon, Herriman, UT (US); Monte Johnson, Springville, UT (US)

(21) Appl. No.: 16/593,841

(22) Filed: Oct. 4, 2019

Related U.S. Application Data
(60) Provisional application No. 62/741,379, filed on Oct. 4, 2018.

(51) Int. Cl. G06Q 30/02

(52) U.S. Cl. CPC G06Q 30/0271; G06Q 30/0255

(57) ABSTRACT

A method of personalized advertising, comprising publishing a need or want about a known user; searching for one or more needs-based advertisements based on the user's need; and transmitting the one or more advertisements to the user is disclosed. A method for predicting a user's initial state, comprising collecting data about a user in a personal database; identifying the user's current state using the personal database; identifying the user's current role using the personal database; and predicting the user's initial state using the current state, current role, and historical trends recorded in the personal database is also disclosed.

### CROSS-REFERENCE TO RELATED APPLICATIONS

This application claims priority to U.S. Provisional Application No. 62/741,379 filed on Oct. 4, 2018, which is incorporated herein by reference in its entirety.

### TECHNICAL FIELD

The present disclosure relates to digital advertising. More particularly, it relates to a method of providing personalized needs-based advertising.

### BACKGROUND

Advertising is changing. Historically, ads could only target broad groups based upon measured media consumption: what age groups listened to specific radio stations, Nielsen ratings certified TV shows that deliver specific audiences, and newspapers that have certain geographical coverage. With the advent of computers and specifically mobile computing this has changed.

Facebook and Google are determined to gather all information possible about individuals into corporate data silos and use it to target specific advertising to specific consumers. AI initiatives are heavily invested in mining these data silos to determine relevant needs and wants for individuals.

Advertising is a one-sided relationship where advertisers pay platform providers (i.e., search engines, social media, digital media/entertainment) to place ads based on data mined from consumers. Consumers get nothing in exchange for their data other than the occasional ad that is actually relevant to the consumer's wants and needs.

Determining needs and wants is difficult. Surmising a need from a web page visit is not simple. Sometimes the web page visit is really the start of a search for a specific product. Sometimes it only represents a momentary interest and not a need or want at all. Facebook and Google continue engaging AI to better distinguish real needs and wants from fleeting interest. In other words, to improve their ability to know an individual's current wants or needs.

Real needs and wants are only really known by the individual. All AI efforts can generate is an approximation of need and want. While Facebook and Google continue to improve their AI algorithms, the process requires gathering all possible information sources about individuals to get as close to current state as possible. These efforts are starting to irritate individuals despite some of the benefits that are offered in return. Additionally, consumers are starting to pay attention to the enormous amounts of money that these companies are generating on the back of their individual information caches. Consumers are starting to push back.

An identified need and/or want is the most desired unit of advertising. If the need is known in advance, the advertising can be extremely specific in providing a solution. Needs and wants exist in all areas of the economy. An advertising module capable of exposing individual needs and wants to potential solutions is extremely valuable. Advertisers would then be able to compete for the “buying customer” knowing exactly what is desired. There is a need for a solution that provides such specific information.

### SUMMARY

In a first aspect, the disclosure provides a method of personalized advertising, comprising publishing a need or want about a known user; searching for one or more needs-based advertisements based on the user's need; and transmitting the one or more advertisements to the user.

In a second aspect, the disclosure provides a method for predicting a user's initial state, comprising collecting data about a user in a personal database; identifying the user's current state using the personal database; identifying the user's current role using the personal database; and predicting the user's initial state using the current state, current role, and historical trends recorded in the personal database.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a flowchart showing an exemplary embodiment according to the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “current state” is meant to refer to the current situation of a specific user. The user's current state is based on objective facts such as location, time of day, schedule or calendar, relationships, medical or dietary restrictions, and personal preferences and habits, among many other personal characteristics.

As used herein, “current role” is meant to refer to any of the various functions fulfilled by individuals at different times and places. Roles include functions or relationships such as spouse, parent, child, sibling, employee, employer, supervisor, customer, vendor, manager, volunteer, friend, neighbor, acquaintance, member (e.g., of a club, church, or other organization), and many others.

As used herein, “initial state” is meant to refer to the needs and priorities of a user. The user's initial state is based on interpretation of current state, role, and historical trends for the specific user and is predicted using artificial intelligence (“AI”). Demographic data (e.g., web search data, etc.) may also be used to predict initial state.

As used herein, “personal database” is meant to refer to a secure collection of information about a specific user. The data may originate with the user, third party sources such as individuals (e.g., family and friends) and organizations (e.g., banks, social media) with whom the user has a relationship, digital devices utilized by the user (e.g., smart phone), user's cloud services, or any other available source. The personal database may be a distributed personal database (“DPD”).

As use herein, “distributed personal database” is meant to refer to a database in which different pieces of data are located in different locations (e.g., different devices, servers, locations) that are connected logically into a single database inside a secure boundary.

As used herein, “personal computing environment” is meant to refer to one or more applications or programs that a user selects to connect to his personal database and a set of rules and security protocols governing the ability of applications to access data and communicate with the user or third parties. The applications in the personal computing environment may access the personal database to determine the user's current state and provide personalized needs-based advertising or third party offers.

As used herein, “persistent ID” is meant to refer collectively to the personal database and personal computing environment. Third party applications may be added to the persistent ID, but third-party developers are not allowed access inside the persistent ID and cannot collect data from applications within the persistent ID.

As used herein, “daisy-chain computing” is meant to refer to the use of intermediate computations to be utilized by higher-level computations. This allows complex information to be derived from simple data points.

As used herein, “known consumer” is meant to refer to a customer whose wants and needs are known based on their individual circumstances rather than based on demographic averages and/or search engine usage.

As used herein, “qualified vendor” is any person or party capable of meeting all aspects of an identified user need including, but not limited to, time restraints, location, quality, and budget or price.

### Exemplary Embodiments

The present disclosure relates to methods for determining the current wants and/or needs of a specific user and providing ads or proposals based on those current wants and/or needs. The user may be an individual or organization. The disclosed system provides personal data silos allowing everyone to control access to their own data. By increasing individual data privacy and finally collecting all personal information into a personal database within an access-controlled environment (security) preventing outsider use of the personal current state, individuals can fully represent their own personal current state. Using the disclosed system, advertising can be driven by personal needs and/or wants with very specific ads targeting known consumers (not just potential consumers). Resulting revenue channels are fully supported by consumers and commercial interests alike as all benefit from the increase in directed advertising to known consumers.

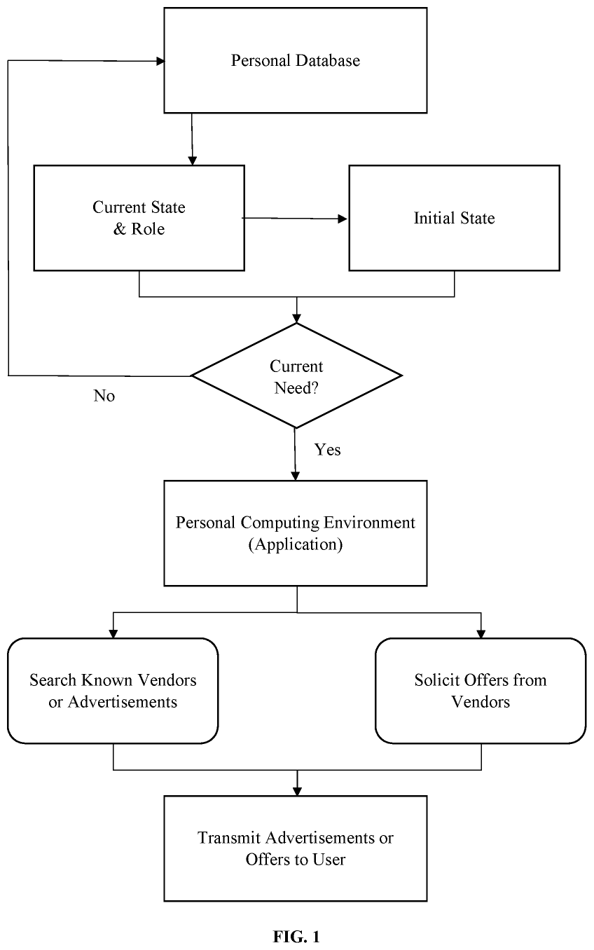

Now referring to FIG. 1, an exemplary embodiment of a method for providing targeted advertising is shown. In various exemplary embodiments, the disclosed method uses a Personal Database (“PDB”) to securely aggregate information about an individual user. The information can be drawn from a variety of sources or pushed to the PDB by those sources. Sources of information in the PDB include the user, others with whom the user has interacted, third party vendors (e.g., the user's bank, doctor, etc.), social media sites, churches, volunteer organizations, user's digital devices (e.g., smart phone, computer, etc.), and other online sources of information (e.g., Google). Rather than pieces of an individual's information being stored separately in many big data silos (e.g., bank, store, Facebook, etc.), it is stored (as an aggregate) in a single database (e.g., distributed database) inside a security barrier with access controlled by the user. The PDB contains, at a minimum, data on the user's current state, role, and historical behavior. It may also contain historical data on predictions of initial state and the user's behavior at those times (i.e., accuracy of past predictions). All of this information, and possibly more, is used to predict initial state.

In various exemplary embodiments, the disclosed method uses a Personal Computing Environment (“PCE”) that includes security barriers and protocols protecting the user's data. The user can import selected applications into the PCE. Applications inside the PCE are inaccessible to third parties, including the developers of the applications installed in the PCE. Applications inside the PCE are prevented from leaking or otherwise transmitting PDB data used in the computation or the actual results of computations outside of the PID security barriers. Installed applications operate on the user's data to determine the user's current state and role, predicted initial state, use those factors (i.e., current state, role, and initial state) to identify appropriate advertisements or solicit appropriate offers from vendors.

In various exemplary embodiments, the system creates a Persistent ID (“PID”) that securely contains both the data (PDB) and applications (PCE) that can access that data. Access to the PID is controlled by the user.

In various exemplary embodiments, needs and/or wants are identified using “daisy-chain” computing. The system takes a series of factors into account to determine the likelihood and seriousness of any need. For example, the need for a meal can be approximated based on time of day. The more complex computations of the disclosed method can take into account additional factors such as how recently a user has eaten, typical mealtimes, typical eating patterns based on the date (i.e., day of the week, month, or year; holidays), and dietary or health requirements, among others. Once a need is identified, additional factors including, but not limited to, time of day, available time, location, and budget can be used to identify a user-specific need that may be fulfilled by one or more appropriate ads (or solicited through publishing the now-identified need).

For example, the system may determine that it is approaching a user's normal lunch time. Based on factors including location, available time, budget, and dietary requirements, the system identifies one or more qualified vendors capable of meeting all aspects of the user's need and pulls all ads that meet all of the relevant criteria and delivers only those ads to the user. Alternatively, the system may solicit offers or advertisements from qualified vendors meet the now-identified need and/or want. The system may use either or both methods to find one or more directed ads from a variety of qualified vendors to fulfil the need and/or want.

In various exemplary embodiments, the PID for one user can cooperate with the PID of one or more other users to identify ads or solicit offers for a joint endeavor, such as a group of co-workers going out for lunch. For example, a person hosting a dinner party may request menu or recipe options that meet the dietary needs or restrictions (e.g., lactose intolerance) of all participants. The system draws upon the PID for each attendee to provide dietary information to provide recommendations and opportunities to purchase ingredients or prepared food.

In various exemplary embodiments, the AI system learns about the user by tracking their response or lack of response to offers to improve its ability to predict initial state and select the best advertisement without requiring direct user input. The user's habits create a virtual image of the user's personality and preferences. Over time, the AI is able to emulate the user's behaviors or personality and find solutions that best fit the user's desires in finding solutions to wants or needs.

In various exemplary embodiments, the system selects an installed application to fulfill an identified need with an advertisement. Alternatively, the application may solicit offers from vendors in position to fulfill the identified need.

In various exemplary embodiments, the user's response to the advertisement is recorded and provides feedback into the PID. The user's potential responses include accepting the advertised offer, rejecting advertised offer, delegating the decision to someone else, deferring a decision for selected time, or deferring a decision indefinitely (including no decision). The decision is reported back to the PID and is the entire transaction becomes a recorded response that is used to predict needs and select advertisements. Recorded responses are the baseline daisy-chain computing module. These decisions may also be reported to advertisers to track the effectiveness of their advertisements.

In various exemplary embodiments, the PID will include a wide variety of applications that deal with many different aspects of the user's life. Although the applications deal with different aspects of life, those areas will constantly overlap and interact. For example, dietary habits will be impacted by health requirements and budgetary constraints. Financial health is directly related to spending habit. Applications that deal with basic functions are a source of data in the PID for more advanced applications. Thus, recorded responses to one application will create patterns in the PID that will improve initial state predictions and the responses of all applications. Simple behavioral patterns (e.g., what a person typically eats for lunch) can become part of more complex patterns of recorded responses (e.g., overall dietary habits) that can impact other areas of life (e.g., effect of spending on food, transportation, etc. on overall financial health or retirement planning). Applications use output from other applications to create a hierarchy of complexity in PID decisions. Over time, the PID AI creates an increasingly accurate model of the user's behavior and becomes more accurate in predicting initial state, determining current wants or needs, and selecting the best response. This also enables the creation of more complex applications to deal with more complex needs and solutions. For example, an application may be able to draw data from applications related to personal health and wellness, medical care providers, and dining to find connections, analyze potential causes, and propose solutions.

The advertising leads generated by the disclosed system are much more likely to result in purchases than traditional online advertising making them far more valuable. Revenue from the advertisements may be profitably distributed among system operators, application developers, and/or the actual individual users with the needs and/or wants.

The invention has been described with reference to various specific and preferred embodiments and techniques. Nevertheless, it is understood that many variations and modifications may be made while remaining within the spirit and scope of the invention.

What is claimed is:

1. A method of personalized advertising, comprising:
publishing a need or want about a known user;
searching for one or more needs-based advertisements based on the user's need; and
transmitting the one or more advertisements to the user.

2. The method of claim 1 further comprising:
a method of identifying the need, comprising:
collecting data about a user in a personal database;
identifying the user's current state using the personal database;
identifying the user's current role using the personal database;
predicting the user's initial state based on the user's current state and current role; and
determining a current need or want based on the user's current state, current role, and initial state.

3. The method of claim 1 further comprising applications that are used to search for a needs-based advertisement and to provide feedback to the personal database on the selection.

4. The method of claim 1 wherein the step of searching for one or more needs-based advertisements further comprises searching within one or more databases for qualified vendors and transmitting the at least one offer to the user.

5. The method of claim 1 wherein the step of searching for one or more needs-based advertisements further comprises:
soliciting needs-based offer from one or more qualified vendors online;
receiving at least one offer in response to the solicitation from at least one qualified vendor; and
transmitting the at least one offer to the user.

6. The method of claim 1 further comprising providing feedback on the user's response into the personal database.

7. The method of claim 1 further comprising collecting revenue from advertisers.

8. The method of claim 3 further comprising collecting revenue from advertisers and distributing a portion of the revenue to the developers of the applications used to select the needs-based advertisement.

9. A method for predicting a user's initial state, comprising:
collecting data about a user in a personal database;
identifying the user's current state using the personal database;
identifying the user's current role using the personal database; and
predicting the user's initial state using the current state, current role, and historical trends recorded in the personal database.

10. The method of claim 9 further comprising:
determining a current need based on the user's current state, current role, and initial state;
proposing a solution to the current need or want;
recording the user's response to the proposed solution; and
adding the user's response to the personal database.

11. The method of claim 9 wherein the proposed solution is delivered to the user in the form of an advertisement or offer.
